(19) United States
(12) Patent Application Publication
(10) Pub. No.: US 2011/0238417 A1
(43) Pub. Date: Sep. 29, 2011

(54) SPEECH DETECTION APPARATUS

(75) Inventors: Koichi YAMAMOTO, Tokyo (JP); Kaoru SUZUKI, Kanagawa (JP); Tadashi AMADA, Tokyo (JP)

(73) Assignee: KABUSHIKI KAISHA TOSHIBA

(21) Appl. No.: 12/881,808

(22) Filed: Sep. 14, 2010

(30) Foreign Application Priority Data
Mar. 26, 2010 (JP) 2010-073700

(51) Int. Cl. G10L 15/20

(52) U.S. Cl. 704/233; 704/E15.04

(57) ABSTRACT

According to one embodiment, a speech detection apparatus includes a first acoustic signal analyzing unit configured to analyze a frequency spectrum of a first acoustic signal, and a feature extracting unit configured to remove a frequency spectrum of the first acoustic signal from a third acoustic signal, which is obtained by suppressing an echo component of the first acoustic signal contained in a second acoustic signal, so as to extract a feature of a frequency spectrum of the third acoustic signal.

### CROSS-REFERENCE TO RELATED APPLICATIONS

This application is based upon and claims the benefit of priority from Japanese Patent Application No. 2010-073700, filed on Mar. 26, 2010; the entire contents of which are incorporated herein by reference.

### FIELD

Embodiments described herein relate generally to a speech detection apparatus used for a speech recognition having a barge-in function.

### BACKGROUND

In a speech recognition system mounted, for example, to a car navigation, a barge-in function capable of recognizing a speech of a user even during a reproduction of a guidance speech has been developed (see JP-A 2005-84253 (KOKAI), JP-B 3597671 (TOROKU), JP-A 11-500277 (KOHYO), US 2009/0254342, JP-A 2009-251134 (KOKAI), and JP-B 4282704 (TOROKU)). JP-A 2005-84253 (KOKAI), JP-B 3597671 (TOROKU), JP-A 11-500277 (KOHYO), and US 2009/0254342 describe that a threshold value for a feature is adjusted according to a power of a guidance speech so as to prevent an erroneous detection caused by a residual echo.

JP-A 2008-5094 (KOKAI), JP-A 2006-340189 (KOKAI), and WO 2005/046076 disclose techniques for suppressing an echo by utilizing a frequency spectrum of a guidance speech. In JP-A 2008-5094 (KOKAI), JP-A 2006-340189 (KOKAI), and WO 2005/046076, the residual echo is suppressed for each of frequency bands during a process of generating an acoustic signal outputted from an echo cancel, unit.

In the techniques disclosed in JP-A 2005-84253 (KOKAI), JP-B 3597671 (TOROKU), JP-A 11-500277 (KOHYO), and US 2009/0254342, the performance of the echo cancel unit is insufficient. Therefore, when a feature of the residual echo increases to a level substantially equal to that of a speech of a user, the speech of the user cannot correctly be detected.

In the techniques disclosed in JP-A 2008-5094 (KOKAI), JP-A 2006-340189 (KOKAI), and WO 2005/046076, because probability that the residual echo component is contained in a feature during the process of extracting the feature is high, erroneous detection between speech and non-speech may occur.

### BRIEF DESCRIPTION OF THE DRAWINGS

FIG. 1 is a diagram illustrating a speech recognition system provided with a speech detection apparatus according to a first embodiment;

FIG. 2 is a view illustrating a configuration of an echo cancel unit;

FIG. 3 is a diagram illustrating a configuration of the speech detection apparatus;

FIG. 4 is a flowchart illustrating an operation of the speech recognition system;

FIG. 5 is a view illustrating feature variations;

FIG. 6 is a diagram illustrating a speech recognition system provided with a speech detection apparatus;

FIG. 7 is a diagram illustrating a configuration of the speech detection apparatus; and

FIG. 8 is a flowchart illustrating an operation of the speech recognition system.

### DETAILED DESCRIPTION

In general, according to one embodiment, a speech detection apparatus includes a first acoustic signal analyzing unit configured to analyze a frequency spectrum of a first acoustic signal; and a feature extracting unit configured to remove a frequency spectrum of the first acoustic signal from a third acoustic signal, which is obtained by suppressing an echo component of the first acoustic signal contained in a second acoustic signal, so as to extract a feature of a frequency spectrum of the third acoustic signal.

Exemplary embodiments of a speech detection apparatus will be described below with reference to the attached drawings.

### First Embodiment

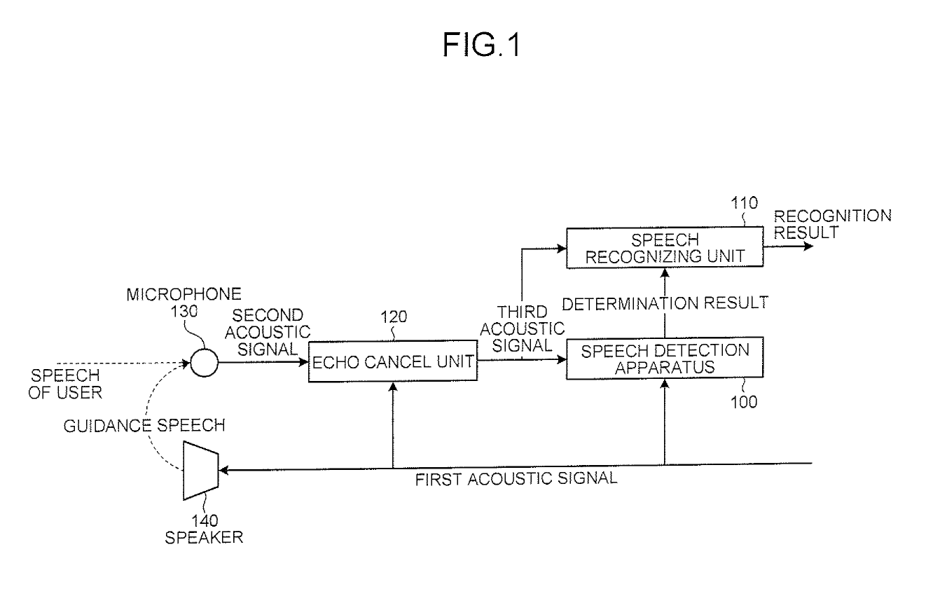

FIG. 1 is a diagram illustrating a speech recognition system provided with a speech detection apparatus 100 according to a first embodiment. The speech recognition system has a barge-in function for recognizing a speech of a user even during a reproduction of a guidance speech. The speech recognition system includes a speech detection apparatus 100, a speech recognizing unit 110, an echo cancel unit 120, a microphone 130, and a speaker 140. When a first acoustic signal prepared beforehand as a guidance speech is reproduced from the speaker 140, a second acoustic signal that contains the first acoustic signal and a speech of a user is acquired by the microphone 130. The echo cancel unit 120 removes (cancels) an echo component of the first acoustic signal contained in the second acoustic signal. The speech detection apparatus 100 determines whether a third acoustic signal outputted from the echo cancel unit 120 is a speech or non-speech. Based on the result of the speech detection apparatus 100, the speech recognizing unit 110 identifies the speech segment of the user contained in the third acoustic signal in order to perform a speech recognition process for this segment. The operation and process of the speech recognition system will be described below in detail.

Firstly, the speech recognition system reproduces from the speaker 140, as a first acoustic signal, a guidance speech that promotes a user to input a speech. The guidance speech includes, for example, “leave a message at the sound of the beep. Beep”. The microphone 130 acquires the speech of the user, such as “today's weather”, as the second acoustic signal. In this case, the first acoustic signal reproduced from the speaker 140 can be mixed with the second acoustic signal as the echo component.

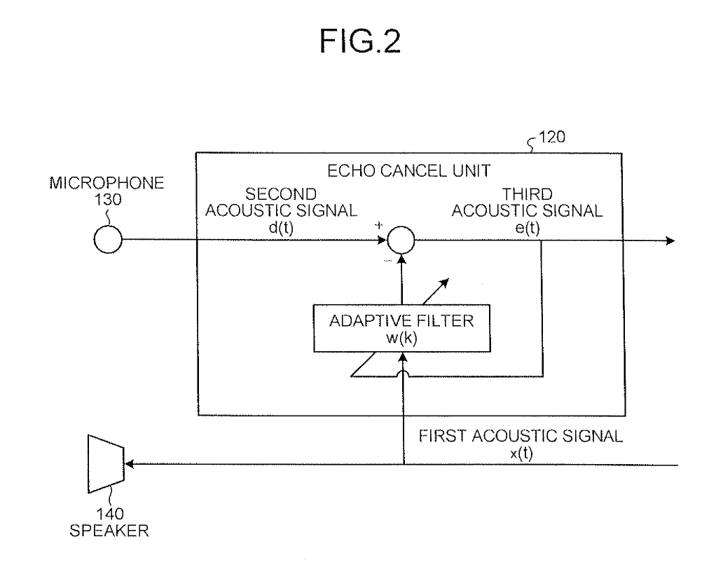

Subsequently, the echo cancel unit 120 will be described. FIG. 2 is a diagram illustrating the configuration of the echo cancel unit 120. The echo cancel unit 120 cancels the echo component of the first acoustic signal contained in the second acoustic signal acquired by the microphone 130. The echo cancel unit 120 estimates the property of the echo path from the speaker 140 to the microphone 130 with an FIR adaptive filter. For example, when the first acoustic signal that is digitized with a sampling frequency of 16000 Hz is defined as x(t), the second acoustic signal is defined as d(t), and an adaptive filter coefficient having a filter length of L is defined as w(t), the third acoustic signal e(t) from which the echo component has been canceled can be calculated by equation 1.

$$e ( t ) = d ( t ) - y ( t ) \\ \begin{matrix}y ( t ) = {\sum }_{i = 1}^{L} {w}_{i} ( t ) \cdot x ( t - i + 1 ) \\ = {W ( t )}^{T} X ( t )\end{matrix} \qquad ( 1 )$$

The adaptive filter coefficient w(t) is updated by equation 2 with the use of NLMS algorithm, for example.

$$W ( t + 1 ) = W ( t ) + \frac{α}{{x ( t )}^{T} x ( t ) + γ} e ( t ) x ( t ) \qquad ( 2 )$$

Here, α is a step size for adjusting the updating speed, and γ is a small positive value for preventing that the term of the denominator becomes zero.

If the adaptive filter can correctly estimate the property of the echo path, the echo component of the first acoustic signal contained in the second acoustic signal can completely be canceled. However, an estimation error is generally produced due to insufficient update of the adaptive filter or rapid variation in the echo path property, so that the echo component of the first acoustic signal remains in the third acoustic signal. Therefore, in the speech recognition system having the barge-in function, a speech detection apparatus that robustly operates against the residual echo is required.

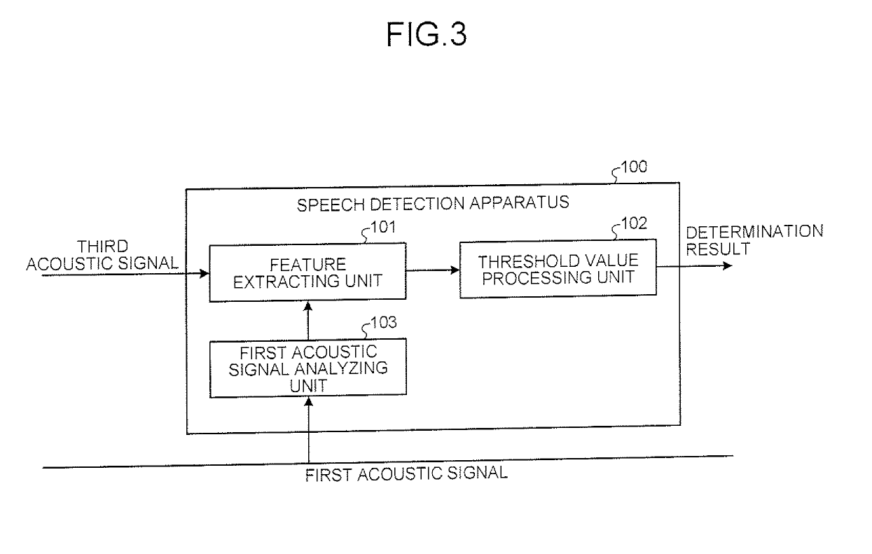

The operation of the speech detection apparatus 100 will next be described. The speech detection apparatus 100 is configured to detect the speech of a user from the third acoustic signal containing the residual echo. FIG. 3 is a diagram illustrating the configuration of the speech detection apparatus 100. The speech detection apparatus 100 includes a feature extracting unit 101, a threshold value processing unit 102, and a first acoustic signal analyzing unit 103. The feature extracting unit 101 extracts a feature from the third acoustic signal. The threshold value processing unit 102 compares the feature and a first threshold value so as to determine whether the third acoustic signal is a speech or non-speech. The first acoustic signal analyzing unit 103 analyzes the frequency spectrum of the first acoustic signal. The speech detection apparatus 100 analyzes the frequency spectrum of the first acoustic signal to detect a frequency that has high probability of containing the residual echo. The feature extracting unit 101 removes, from the third acoustic signal, information at the frequency that has high probability of containing the residual echo so as to extract the feature in which the affect of the residual echo is reduced. The operation flow of the speech recognition system according to the first embodiment will be described below.

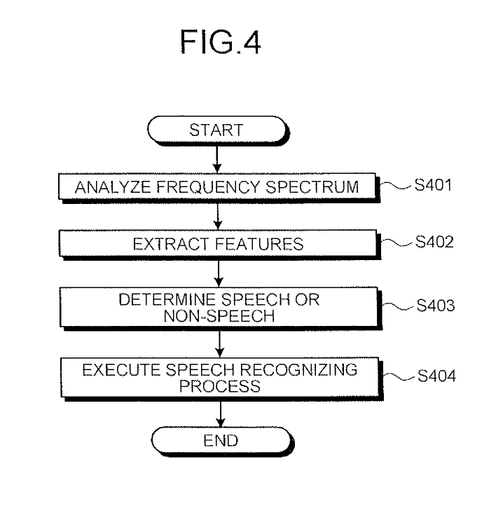

FIG. 4 is a flowchart illustrating the operation of the speech recognition system according to the first embodiment.

In step S401, the first acoustic signal analyzing unit 103 analyzes the frequency spectrum of the first acoustic signal in order to detect the frequency that has high probability of producing the residual echo. Firstly, the first acoustic signal analyzing unit 103 divides the first acoustic signal x(t), which is reproduced as the guidance speech, into frames having a frame length of 25 ms (400 samples) and an interval of 8 ms (128 samples). A hamming window can be used for the frame division. Then, the first acoustic signal analyzing unit 103 performs zero-padding to 112 points, and then, applies discrete Fourier transform to 512 points for the respective frames. Then, the first acoustic signal analyzing unit 103 performs a smoothing operation to the acquired frequency spectrum X_{f} (k) (power spectrum) in a time direction with equation 3, which is a recursive equation.

X′_{f}(k)=μ·X′_{f}(k−1)+(1−μ)·X_{f}(k) (3)

Here, X′_{f} (k) is a frequency spectrum after being subjected to the smoothing in the frequency index f, and μ is a forgetting factor adjusting the degree of the smoothing. μ can be set to about 0.3 to 0.5. Since the first acoustic signal is transmitted in the echo path from the speaker 140 to the microphone 130, a time lag is produced between the first acoustic signal and the residual echo contained in the third acoustic signal. The above-mentioned smoothing process is to correct the time lag. With the smoothing process, the component of the frequency spectrum in the current frame is mixed into the frequency spectrum of the subsequent frame. Therefore, the time lag between the result of the analysis and the echo component in the third acoustic signal can be corrected by analyzing the frequency spectrum subjected to the smoothing process.

Then, the first acoustic signal analyzing unit 103 analyzes the frequency spectrum of the acoustic signal. In the first embodiment, the first acoustic signal analyzing unit 103 detects a main frequency (hereinafter referred to as “main frequency”) constituting the first acoustic signal. Specifically, the first acoustic signal analyzing unit 103 analyzes the frequency spectrum of the first acoustic signal, and detects the frequency having a high power as the main frequency. At the main frequency, the power of the first acoustic signal outputted from the speaker 140 is high. Accordingly, the probability that the residual echo is contained is high at this frequency. In order to detect the main frequency, the first acoustic signal analyzing unit 103 compares the frequency spectrum X′_{f} (k) subjected to the smoothing process and a second threshold value THₓ (k). The result of the analysis R_{f} (k) is expressed by equation 4.

if X′_{f}(k)>THₓ(k) R_{f}(k)=0

else R_{f}(k)=1 (4)

The frequency attaining R_{f} (k)=0 is the main frequency constituting the first acoustic signal. The second threshold value THₓ (k) has to have a magnitude suitable for the detection of the frequency that has high probability of containing the residual echo. When the second threshold value is set to be a value greater than the power of the silent segment: (the segment not including the guidance speech) of the first acoustic signal, it can be prevented that the frequency at which the residual echo is not produced is detected as the main frequency. Further, the average value of the frequency spectrum in the respective frames can be set to be the second threshold value as represented by equation 5. In this case, the second threshold value dynamically changes for every frame.

$${TH}_{x} ( k ) = \frac{1}{257} {\sum }_{f = 0}^{257 - 1} {X}_{f}^{′} ( k ) \qquad ( 5 )$$

In addition, the threshold value processing unit 102 sorts the power of the frequency spectrum of the respective frames in ascending order, and can detect the frequencies falling within the top X % (e.g., 50%) as the main frequencies. Alternatively, the frequency that is greater than the second threshold value and corresponds to the top X % (e.g., 50%) as a result of the sort in ascending order may be detected as the main frequency.

In step S402, the feature extracting unit 101 extracts the feature, which represents the speech activity of the user, from the third acoustic signal with the use of the analysis result (main frequency) obtained at the first acoustic signal analyzing unit 103. Firstly, the feature extracting unit 101 divides the third acoustic signal e(t) outputted from the echo cancel unit 120 into frames having a frame length of 25 ms (400 samples) and an interval of 8 ms (128 samples). A hamming window can be used for the frame division. Then, the feature extracting unit 101 performs zero-padding to 112 points, and then, applies discrete Fourier transform to 512 points for the respective frames. Then, the feature extracting unit 101 extracts the feature by using a frequency spectrum E_{f} (k) thus obtained and the analysis result R_{f} (k) from the first acoustic signal analyzing unit 103. In the present embodiment, the average value (hereinafter referred to as “average SNR”) of SNR for each frequency is extracted as the feature.

$${SNR}_{avrg} ( k ) = \frac{1}{M ( k )} \cdot {\sum }_{f = 0}^{257 - 1} {snr}_{f} ( k ) \cdot {R}_{f} ( k ) \\ {snr}_{f} ( k ) = {log}_{10} ( \frac{MAX ( {N}_{f} ( k ) , {E}_{f} ( k ) )}{{N}_{f} ( k )} ) \qquad ( 6 )$$

Here, SNR_{avrg}(k) represents the average SNR, and M(k) represents the number of the frequency indexes that are not determined to be the main frequency at the kth frames. N_{f} (k) represents the estimated value of the frequency spectrum of a background noise and is calculated, for example, from the average value of the frequency spectrum in the top 20 frames of the third acoustic signal. The feature extracting unit 101 removes the information at the frequency (R_{f} (k)=0) that is determined to be the main frequency as a result of the analysis, thereby extracting the feature. The main frequency is a frequency having a high power of the first acoustic signal, and highly probably contains the residual echo. Accordingly, the main frequency is removed upon extracting the feature, whereby the feature from which the affect of the residual echo is removed can be extracted.

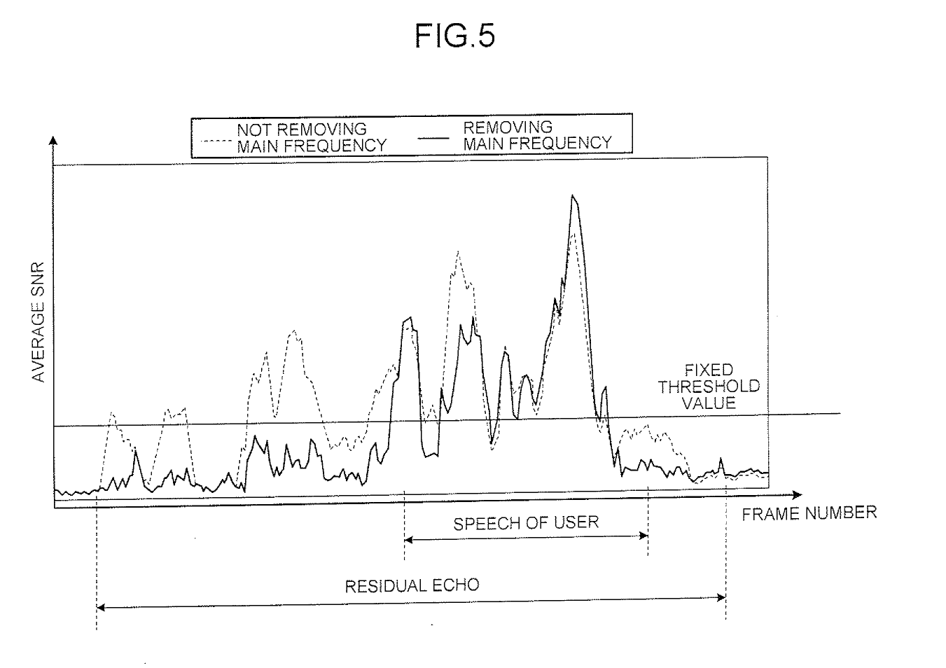

FIG. 5 is a diagram illustrating feature variations before and after the main frequency component is removed. It is understood from FIG. 5 that the value of the feature in the residual echo segment is decreased by removing the main frequency component. Thus, the difference in the features between the speech segment of the user and the residual echo segment becomes apparent, whereby a speech or non-speech can correctly be determined even by using a fixed threshold value. In the conventional techniques (see JP-B 3597671 (TOROKU), JP-A 11-500277 (KOHYO), and US 2009/0254342), only the threshold adjustment according to the power of the first acoustic signal is executed, so that the effect of improving the feature itself as is found in the present embodiment cannot be obtained. The feature extracted at the feature extracting unit 101 may be any one, so long as it utilizes the frequency spectrum of the third acoustic signal. For example, the normalized spectrum entropy described in JP-A 2009-251134 (KOKAI) can be used.

In step S403, the threshold value processing unit 102 compares the feature extracted at the feature extracting unit 101 and the first threshold value, thereby determining a speech or non-speech in a frame unit. When the first threshold value is TH_{VA} (k), the determination result in a frame unit is as represented by equation 7.

if SNR_{avrg}(k)>TH_{VA}(k) The kth frame is a speech

else The kth frame is a non-speech (7)

In step S404, the speech recognizing unit 110 identifies the segment of the speech of the user by using the result of the speech detection in the frame unit outputted from the threshold value processing unit 102, and executes the speech recognizing process. JP-B 4282704 (TOROKU) describes the method of identifying the segment (start and terminal end positions) of the speech of the user from the result of the speech detection in a frame unit. In JP-B 4282704 (TOROKU), the speech segment of the user is determined by using the determination result in the frame unit and the number of the successive frames. For example, when there are successive 10 frames that are determined to be a speech, the frame that is first determined to be the speech in the successive frames is defined as a start position. When there are 15 successive frames that are determined to be a non-speech, the frame that is first determined to be the non-speech in the successive frames is defined as a terminal position. After identifying the speech segment of the user, the speech recognizing unit 110 extracts from the segment a feature vector for the speech recognition, which vector is obtained by combining a static feature such as MFCC and a dynamic feature represented by Δ·ΔΔ. Then, the speech recognizing unit 110 compares the acoustic model (HMM) of a vocabulary to be recognized that is learned beforehand to the feature vector series, and outputs the vocabulary, which has the maximum-likelihood score, as the recognizing result.

As described above, in the present embodiment, the affect of the residual echo is removed from the feature of the speech detection by using the frequency spectrum of the first acoustic signal. With this, the feature for the residual echo can be suppressed, whereby a speech or non-speech can correctly be determined without using conventional threshold adjustment techniques (see JP-B 3597671 (TOROKU), JP-A 11-500277 (KOHYO), and US 2009/0254342). In one conventional threshold adjustment technique (see JP-A 2009-251134 (KOKAI)), when the residual echo increases, the feature (power) in the residual echo segment increases to the level substantially equal to the level of the feature (power) of the speech segment of the user, with the result that the erroneous detection for the residual echo cannot be avoided. In contrast, since the feature in the residual echo segment can be suppressed according to the present embodiment, the erroneous detection for the residual echo can be reduced. In the conventional techniques (see JP-A 2008-5094 (KOKAI), JP-A 2006-340189 (KOKAI), and WO 2005/046076), the residual echo component is highly probably contained in the feature extracted from the third acoustic signal. In contrast, since the information at the frequency that has high probability of containing the residual echo is removed during the process of extracting the feature, the feature from which the affect of the residual echo component is removed can be extracted from the third acoustic signal according to the present embodiment.

### Second Embodiment

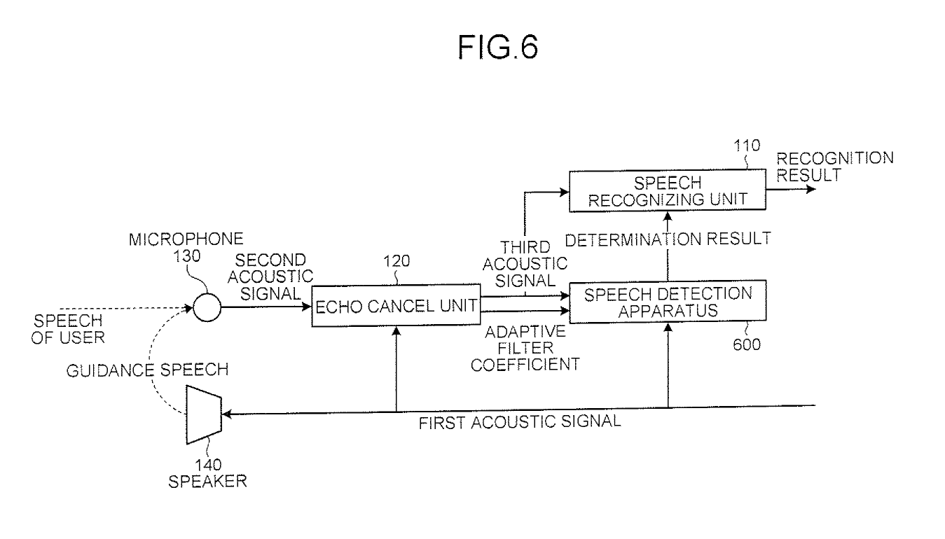

FIG. 6 is a diagram illustrating a speech recognition system provided with a speech detection apparatus 600 according to a second embodiment. The speech recognition system according to the present embodiment is different from that in the first embodiment in that the speech detection apparatus 600 refers to the adaptive filter coefficient updated at the echo cancel unit 120. The configuration same as that in the first embodiment will not be described again.

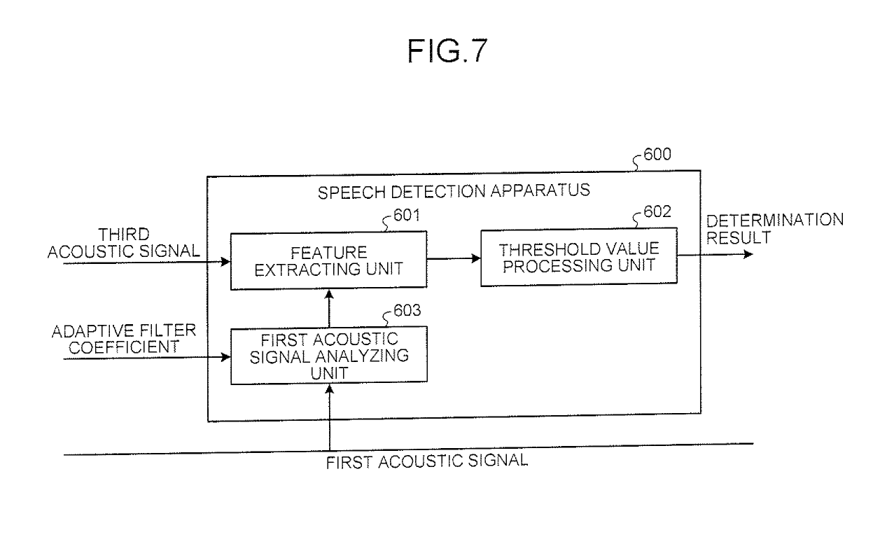

FIG. 7 is a diagram illustrating a configuration of the speech detection apparatus 600. The speech detection apparatus includes a feature extracting unit 601, a threshold value processing unit 602, and a first acoustic signal analyzing unit 603. The feature extracting unit 601 extracts a feature from a third acoustic signal. The threshold value processing unit 602 compares the feature and a first threshold value so as to determine whether the third acoustic signal is a speech or non-speech. The first acoustic signal analyzing unit 603 analyzes the frequency spectrum of the first acoustic signal. The operation flow of the speech recognition system according to the second embodiment will be described below.

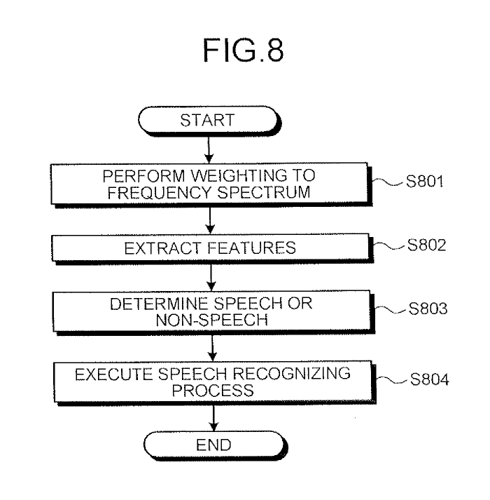

FIG. 8 is a flowchart illustrating the operation of the speech recognition system according to the second embodiment.

In step S801, the first acoustic signal analyzing unit 603 performs weighting according to the magnitude of the frequency spectrum of the first acoustic signal. More specifically, a small weight is applied to the frequency having a high power, while a great weight is applied to the frequency having a small power. At the frequency having a high power, the power of the first acoustic signal outputted from the speaker 140 increases, so that the probability of containing the residual echo also increases. Accordingly, the feature extracting unit 601 applies a small weight to the information at the frequency having a high power, which enables the extraction of the feature having the reduced affect of the residual echo. The weight R_{f} (k) to each frequency is calculated from the frequency spectrum X_{f} (k) of the first acoustic signal by equation 8.

$${R}_{f} ( k ) = \frac{1}{256} ( 1 - \frac{{X}_{f} ( k )}{S ( k )} ) \\ S ( k ) = {\sum }_{f = 0}^{257 - 1} {X}_{f} ( k ) \qquad ( 8 )$$

The total sum of the weights R_{f} (k) is 1, and it becomes small as the value of the frequency spectrum becomes great.

In the second embodiment, the time lag, which is produced by the echo path, between the first acoustic signal and the echo component in the third acoustic signal is estimated from the adaptive filter coefficient updated at the echo cancel unit 120. The adaptive filter coefficient w(t) represents an impulse response of the echo path from when the first acoustic signal is outputted from the speaker 140 and transmitted through an acoustic space to when the first acoustic signal is acquired by the microphone 130 as the second acoustic signal. Therefore, the successive number of the updated filter coefficient w(t), which has an absolute value smaller than a predetermined threshold value, from the head is counted, whereby the time length Dₜᵢₘₑ (hereinafter referred to as “transmission time length”) required for the transmission in the echo path can be estimated. For example, it is supposed that the updated filter coefficient w(t) is a sequence described in equation 9.

W(L)={0, 0, 0, 0, 0, 0, 0, 0, 0, −1, 10, −5, . . . } (9)

When the threshold value of the absolute value of the filter coefficient is set to 0.5, for example, the successive 10 coefficients from the head have absolute values less than the threshold value. This means that a time corresponding to 10 samples is needed to the transmission in the echo path. When the sampling frequency is 16000 Hz, for example, Dₜᵢₘₑ is such that 10÷16000×1000=0.0625 ms.

In step S802, the first acoustic signal analyzing unit 603 adds the correction according to the transmission time length to the analysis result R_{f} (k), so as to obtain the analysis result R′_{f} (k) after the correction as expressed by equation 10.

R′_{f}(k)=R_{f}(k−D_{frame})

D_{frame}=Dₜᵢₘₑ/8 (10)

Here, 8 means a shift width (a unit is ms), and D_{frame} is a value obtained by converting the transmission time length into a frame number. The analysis result R′_{f} (k) after the correction becomes the final analysis result outputted to the feature extracting unit 601 from the first acoustic signal analyzing unit 603. As described above, the echo cancel unit 120 adds a delay corresponding to the transmission time length to the analysis result, whereby the time synchronization between the analysis result and the third acoustic signal can be secured.

In step S802, the feature extracting unit 601 extracts the feature from the third acoustic signal by using the analysis result R′_{f} (k) obtained at the first acoustic signal analyzing unit 603. The average SNR is calculated by equation 11 from the frequency spectrum E_{f} (k) and the analysis result R′_{f} (k).

$${SNR}_{avrg} ( k ) = {\sum }_{f = 0}^{257 - 1} {snr}_{f} ( k ) \cdot {R}_{f}^{′} ( k ) \\ {snr}_{f} ( k ) = {log}_{10} ( \frac{MAX ( {\hat{N}}_{f} ( k ) , {E}_{f} ( t ) )}{{\hat{N}}_{f} ( k )} ) \qquad ( 11 )$$

Steps S803 and S804 are the same as steps S403 and S404, so that the description will not be repeated.

In the present embodiment, the feature is extracted by applying the weight R′_{f} (k) to the SNR (snr_{f}(k)) extracted from each frequency. A small weight is applied to the frequency of the first acoustic signal having a high power, whereby the feature from which the affect of the residual echo is reduced can be extracted.

As described above, in the present embodiment, the feature from which the affect of the residual echo is reduced is extracted by using the frequency spectrum of the first acoustic signal. Thus, the feature for the residual echo can be suppressed, whereby a speech or non-speech can correctly be determined.

The speech detection apparatus according to the embodiments can be realized by using a general-purpose computer as a hardware, for example. Specifically, the respective units of the speech detection apparatus can be realized by allowing a processor mounted to the computer to execute a program. In this case, the speech detection apparatus may be realized by installing the program to the computer beforehand, or may be realized in such a manner that the program is stored in a computer-readable storage medium or is distributed through network, and this program is appropriately installed to the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech detection apparatus comprising:
a first acoustic signal analyzing unit configured to analyze a frequency spectrum of a first acoustic signal; and
a feature extracting unit configured to remove a frequency component of the first acoustic signal from a third acoustic signal, which is obtained by suppressing an echo component of the first acoustic signal contained in a second acoustic signal, and to extract a feature from a frequency spectrum of the third acoustic signal, from which the frequency component of the first acoustic signal is removed.

2. The apparatus according to claim 1, wherein
the first acoustic signal analyzing unit compares power of each frequency component in the frequency spectrum of the first acoustic signal and a threshold value, and
the feature extracting unit removes the frequency component, the power of which is determined to be greater than the threshold value, from the third acoustic signal, and extracts the feature from the frequency spectrum of the third acoustic signal, from which the frequency component of the first acoustic signal is removed.

3. The apparatus according to claim 1, wherein
the first acoustic signal analyzing unit determines whether each frequency component in the frequency spectrum of the first acoustic signal is included in a top X % when the powers of the frequency components are arranged in an ascending order, and
the feature extracting unit removes the frequency component, the power of which is determined to be included in the top X %, from the third acoustic signal, and extracts the feature from the frequency spectrum of the third acoustic signal, from which the frequency component of the first acoustic signal is removed.

4. The apparatus according to claim 1, wherein
the first acoustic signal analyzing unit applies a weight according to the magnitude of the power to each frequency component of the first acoustic signal, and
the feature extracting unit extracts the feature from the frequency spectrum of the third acoustic signal by using the weight applied by the analysis of the first acoustic signal analyzing unit.

5. The apparatus according to claim 1, wherein
the first acoustic signal analyzing unit analyses the frequency spectrum obtained by performing a smoothing process to the frequency spectrum of the first acoustic signal in a time direction.

6. The apparatus according to claim 1, wherein
the first acoustic signal analyzing unit includes an echo cancel unit configured to estimate a time length required for a transmission of the first acoustic signal in an echo path, wherein a delay according to a transmission time length estimated by the echo cancel unit is applied to output the analysis result of the first acoustic signal.

7. The apparatus according to claim 6, wherein
the echo cancel unit updates a filter coefficient by an adaptive algorithm, and
the first acoustic signal analyzing unit estimates the time length required for the transmission of the first acoustic signal in the echo path by using the filter coefficient updated by the echo cancel unit.
